(19) United States
(12) Patent Application Publication
(10) Pub. No.: US 2025/0392338 A1
(43) Pub. Date: Dec. 25, 2025

(54) WATCH STRAP MOBILE PHONE CASE

(71) Applicant: Wei Luo, Huzhou (CN)

(72) Inventor: Wei Luo, Huzhou (CN)

(21) Appl. No.: 18/896,637

(22) Filed: Sep. 25, 2024

(30) Foreign Application Priority Data
Jun. 25, 2024 (CN) 2024214713164

(51) Int. Cl. H04B 1/3888; A45F 5/00; F16M 13/00

(52) U.S. Cl. CPC H04B 1/3888; A45F 5/00; F16M 13/005; A45F 2005/002; A45F 2005/008

(57) ABSTRACT

A mobile phone case with a chuck and a detachable connecting seat on a chuck. A strap is supplied to two ends of the connecting seat. A magnet connects one end of the two straps. The chuck comprises a column protruding from the surface of the case body. A disc is arranged at the end of the column. The diameter of the disc is greater than the diameter of the column. The end of the connecting seat has a first slot for disc insertion and a second for column insertion. The width dimension of the first slot is greater than the width dimension of the second slot, so the insertion of the disc body forms a clamping connection to the seat.

### CROSS REFERENCE TO RELATED APPLICATIONS

This application claims priority to the co-pending Chinese National Application, Ser. No. 2024214713164, filed on Jun. 25, 2024, which is hereby incorporated by reference for all purposes.

### BACKGROUND

A strap-type phone case technical field The utility model relates to a technical field for mobile phone accessories, specifically relating to a strap-type mobile phone case. Background technology: In modern society, mobile phones have become indispensable in people's daily lives. However, in some situations, such as driving or exercising, carrying your phone with you can be inconvenient. To solve the problem of mobile phones being inconvenient to carry, they are usually carried by lanyards or straps. For example, the authorization announcement number CN208143298U discloses a mobile phone case that is convenient to carry during movement, the mobile phone case main body is specifically disclosed, a mobile phone placement groove is arranged inside the front end face of the mobile phone case main body, a fixing hole is arranged inside the rear end face of the mobile phone case body, a fixing spring is installed inside the mobile phone placement groove, a fixed baffle plate is fixedly connected to the front end of the fixing spring, a positioning groove is connected inside the fixing hole, and a fixed block is spirally connected inside the fixing hole, The rear end of the fixed block is fixedly connected with a fixed boss, and the rear end of the fixed boss is connected with an elastic wrist strap, a support strip is installed inside the elastic wrist belt, and the upper end of the support bar is connected with a cotton cloth layer, the upper end of the cotton cloth layer is connected with a mesh air permeable layer, and an elastic wrist strap is connected to the outside of the mesh air permeable layer, a fixed strap is installed at the left end of the elastic wrist band, and the front end of the fixed belt is connected with Velcro with the upper side of the left end of the elastic wrist band, and a buckle is installed on the right side of the elastic wrist band. Although the above-mentioned mobile phone case can realize the purpose of convenient carrying, however, it still has some places that need to be improved; for example, the elastic wristband in the prior art is arranged on the rear end surface of the mobile phone case's main body through a fixing boss and a fixed strap is installed at the left end of the elastic wristband, and a buckle is installed at the right end of the elastic wristband. Because the front end face of the elastic wristband is seamlessly attached to the rear surface of the main body of the mobile phone case, the fixed boss can make the elastic wristband evenly exert force on the main body of the mobile phone case to realize the fixation of the elastic wristband on the main body of the mobile phone case, in the case of non-use, the elastic wristband cannot be removed from the mobile phone case, which will affect the overall appearance of the mobile phone case. In addition, the mobile phone case body is worn on the wrist through the mutual fixation of the buckle and the fixing belt. The fixing strap is fixed on the mobile phone case body, and the different viewing angle needs of the user cannot be realized by rotating different angles. Therefore, further improvements to the existing art are required.

### SUMMARY

A mobile phone case body is provided with a chuck and a detachable connecting seat arranged on the chuck. Two ends of the connecting seat are also respectively supplied with a strap, and one end of the two straps is connected with each other through a magnetic attraction. The chuck comprises a column protruding relative to the surface of the mobile phone case body and a disc body arranged at the end of the column. The diameter of the disc body is greater than the diameter of the column. The side end of the connecting seat is provided with a first slot for disc body insertion and a second slot for column insertion. The width dimension of the first slot is greater than the width dimension of the second slot so that after the disc body is inserted, it can form a clamping connection with the connecting seat; it is further provided with a retractable pushing block inside the connecting seat, and the end of the pushing block is provided with a locking portion. A plurality of keyholes are uniformly arranged in the circumferential direction of the disc body. After the pushing block stretches out in the direction of the disc body, the locking part can optionally be butted against one of the keyholes so that the mobile phone case body is locked and fixed on the connecting seat after adjusting the angle.

### BRIEF DESCRIPTION OF THE DRAWINGS

FIG. 1 is a diagram of the overall structure of the utility model.

FIG. 2 is an exploded view of the utility model shown in FIG. 1.

FIG. 3 is the utility model that discloses an integral structure of FIG. 2.

FIG. 4 is a partial exploded view of the utility model FIG. 1.

FIG. 5 is part of the utility model structural explosion schematic diagram two.

FIG. 6 is a schematic diagram of the strap structure and the utility model's connecting seat.

FIG. 7 is a schematic diagram of the utility model's mobile phone case body, chuck, and folding bracket structure.

### DETAILED DESCRIPTION

The disclosed widgets will become better understood by reviewing the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various widgets are provided. Related features in the examples may be identical, similar, or dissimilar in different examples. For the sake of brevity, related features will not be redundantly explained in each example. Instead, the use of related feature names will cue the reader that the feature with a related feature name may be like the related feature in an example explained previously. Features specific to a given example will be described in that particular example. The reader should understand that a given feature need not be the same or like the specific portrayal of a related feature in any given figure or example.

### A Watch Strap Mobile Phone Case

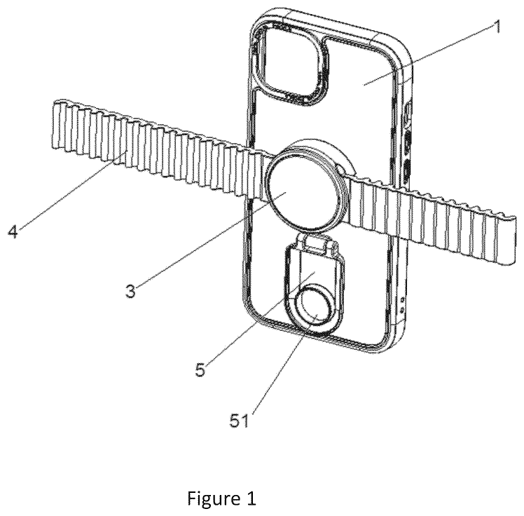

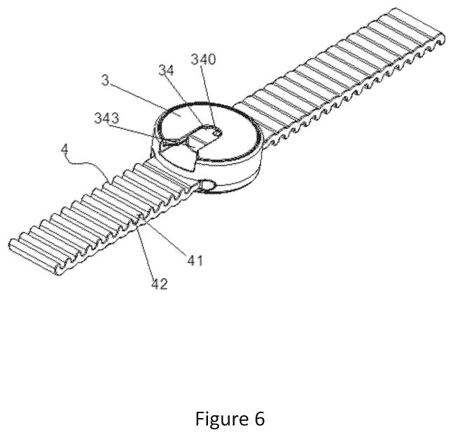

With reference to FIGS. 1 to 7, A WATCH STRAP MOBILE PHONE CASE will now be described.

Utility model content aiming at the existing problems of the prior art. The purpose of the utility model is to provide a strap-type mobile phone case, which is inserted on the connecting seat that is provided with a strap through a chuck that is arranged on the mobile phone case body so that it can be conveniently installed and disassembled according to the needs of use; at the same time, it can be selected to be countered with one of the keyholes through the locking part to realize the locking and fixing after the rotation angle of the mobile phone case. In order to achieve the above purpose, the technical scheme of the utility model is that: a strap-type mobile phone case, comprising: the mobile phone case body, the mobile phone case body is provided with a chuck and a detachable connecting seat mounted on the chuck, two ends of the connecting seat are also respectively provided with a strap, and one end of the two straps is connected with each other through a magnetic attraction; the chuck comprises a column protruding relative from the surface of the mobile phone case body and a disc body arranged at the end of the column, and the diameter of the disc body is greater than the diameter of the column; the side end of the connecting seat is respectively provided with a first slot for disc body insertion and a second slot for column insertion, and the width dimension of the first slot is greater than the width dimension of the second slot, so that after the disc body is inserted, it can form a clamping connection with the connecting seat; Be further provided with a retractable pushing block inside the connecting seat, and the end of the pushing block is provided with a locking portion; A plurality of keyholes are uniformly arranged in the circumferential direction of the disc body, and after the pushing block stretches out in the direction of the disc body, the locking part can optionally be butted against one of the keyholes, so that the mobile phone case body is locked and fixed on the connecting seat after adjusting the angle.

Further, the connecting seat comprises an upper cover, a base, and a base. The first slot is arranged on the base, and the second slot is arranged on the base. After the disc body is inserted into the first slot, the upper end of the disc body forms a counter with the bottom end of the base, and the lower end of the disc body forms a counter with the upper end of the base. Through the above setting, the chuck can be snapped on the connecting seat. Further, the upper cover is provided with a containment chamber for accommodating the pushing block, two linear sliding grooves are symmetrically arranged on the inner wall of the containing cavity, and two guide rails are symmetrically arranged on the outer wall of the pushing block. The guide rails are respectively inserted into the linear spout so that the pushing block can slide in a straight line along the linear sliding groove. Through the above-mentioned arrangement, the push block can be expanded and contracted in a straight line in the upper cover so that the pushing locking part forms a butt with the keyhole. Further, a spring for pushing the push block to slide is arranged between the pushing block and the upper cover. Through the above-mentioned setting, the push block can be subjected to the force of the spring and slide toward the direction of the chuck. Further, an opening for the locking portion to extend out in the direction of the disc body is formed in the bottom center position of the base. With the above arrangement, the locking part can pass through the opening and form a counterpoint with the keyhole. Further, in the pedestal and along the edge of the opening, an arc-shaped stop for limiting the pushing block to make a circular rotation is arranged. Through the above settings, the push block can be more stable when doing linear sliding. Further, the bottom of the pushing block is further provided with a guide hypotenuse that facilitates the insertion of the disc body. Through the above settings, the chuck can be inserted into the connector more smoothly. Further, a positioning flange matched with the disc body is arranged at the central position of the base. Through the above-mentioned arrangement, after the disc body is inserted into the center position of the base, the positioning baffle plate can form a counter-connection with the periphery of the disc body, so that the chuck is inserted into the connecting seat after the chuck is inserted into the connecting seat, and the clamping is fixed more steadily. Further, the two straps are alternately provided with bumps and grooves in their length directions so that after the two straps are connected to each other, the bumps can be correspondingly inserted into the grooves and form a plug-in connection. With the above settings, it is possible to achieve a simpler and more convenient way to wear.

Further, a folding bracket is arranged on the mobile phone case body and is opposite below the chuck, and one end of the folding bracket is hinged with the mobile phone case body so that after the mobile phone case body is disassembled from the connecting seat, the folding bracket can be flipped upwards and covered with the chuck. Through the above-mentioned setting, when wearing the mobile phone, the folding bracket can be flipped up and form a cover for the chuck so as not to affect the overall appearance of the mobile phone case body. It is also possible to flip the folding bracket to a certain angle, so that the folding bracket can be used to support the mobile phone. The beneficial effects of the utility model are that: (1) the utility model discloses a chuck that is arranged on the mobile phone case body is inserted into the connecting seat that is provided with a strap, and when carrying a mobile phone in a way that does not need to be worn, the mobile phone case body or the connecting seat can be pressed to shrink the pushing block, so that the mobile phone case body is conveniently taken out in the mode of pulling out from the connecting seat; When carrying the mobile phone in the mode of need to wear, the chuck can be inserted into the connecting seat from the first slot and the first slot, after the chuck is inserted into the center position of the connecting seat, the spring slides the pushing block to the direction of the chuck by the rebound force, so that the locking part can be inserted into the corresponding ground lock hole and forms a mutual butt, so that the lock fixation of the mobile phone case body and the connecting base is realized. This kind of fixing method between the connecting seat and the chuck has a simple structure and is easy to install and disassemble.

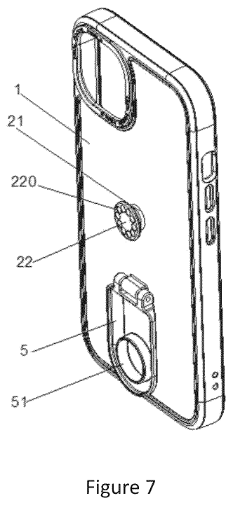

The following section elaborates further on the utility model in conjunction with the accompanying drawings and specific embodiments. The following description is only illustrative and does not limit the scope of protection of the utility model. As shown in FIG. 1-Figure 7, a strap-type mobile phone case comprises mobile phone case body 1, the mobile phone case body 1 is provided with chuck 2 and a detachable connecting seat 3 that is arranged on the chuck 2, the two ends of the connecting base 3 are also respectively provided with a strap 4, and one end of the two strap 4 is connected with each other through magnetic attraction. Specifically, the two strap 4 are respectively provided with a bump 41 and a groove 42 in the direction of their length so that after the two strap 4 are connected to each other, the bump 41 can be correspondingly inserted into the groove 42 and form a plug connection. Through the above-mentioned arrangement, the connecting base 3 of fixing the strap 4 and the chuck 2 fixed on the mobile phone case body 1 are removable so that they can be conveniently disassembled and installed according to the needs of use. In addition, one end of the two straps4 is connected to each other by magnetic attachment, which makes it easy to wear because of its simple structure. In the utility model, by arranging the strap 4 mode on the mobile phone case body 1, the mobile phone can be carried conveniently when driving or exercising, which is conducive to improving the convenience of using the mobile phone. As shown in FIG. 1-Figure 7, the chuck 2 comprises a column 21 protruding from the surface of the mobile phone case body 1 and a disk body 22 arranged at the end of the column 21, and the diameter of the disk body 22 is greater than the diameter of the column 21; the first slot 320 and the second slot 330 for inserting the upright post 21 are respectively formed at the side end of the connecting seat 3, and the width dimension of the first slot 320 is greater than the width dimension of the second slot 330, so that after the disc body 22 is inserted, it can form a clamping connection with the connecting seat 3; Specifically, the connecting seat 3 comprises an upper cover 31, a base 32 and a base 33, the first slot 320 is arranged on the base 32, and the second slot 330 is arranged on the base 33; After the disc body 22 is inserted into the first slot 320, the upper end of the disc body 22 forms a butt with the bottom end of the base 32, and the lower end of the disc body 22 forms a butt with the upper end of the base 33. More specifically, the upper cover 31, the base 32, and the base 33 are fixedly connected through screws. In this embodiment, the first slot 320 and the second slot 330 are extended from the side end of the connecting seat 3 to its central position, and when in use, the disc body 22 is inserted from the first slot 320 and the upright post 21 is inserted from the second slot 330 to the central position of the connecting seat 3, and because the width size of the first slot 320 is greater than the width size of the second slot 330, when the chuck 2 is inserted into the connecting seat 3, the upper end of the disc body 22 forms a counteract with the bottom end of the base 32, The lower end of the disc body 22 forms a butt with the upper end of the base 33, so that the chuck 2 can be snapped in connection Inside seat 3.

As shown in FIG. 1-Figure 7, a retractable pushing block 34 is also arranged inside the connecting seat 3, and the end of the pushing block 34 is provided with a locking portion 340; A plurality of keyholes 220 are uniformly arranged in the circumferential direction of the disc body 22, and after pushing the block 34 stretches out in the direction of the disc body 22, the locking portion 340 can optionally be butted against one of the keyholes 220, so that the mobile phone case body 1 is locked and fixed on the connecting seat 3 after adjusting the angle. Specifically, an opening 321 for the locking portion 340 to stretch out in the direction of the disc body 22 is formed in the bottom center position of the base 32, and in this embodiment, a plurality of keyholes 220 is evenly arranged along the circumferential direction of the disc body 22 are countered with the locking portion 340, so that when the user needs to rotate the angle of the mobile phone case body 1, the locking portion 340 is connected with the keyhole 220 corresponding to the locking portion 340 after rotation, so that the user's demand for angle adjustment of the mobile phone case body 1 is satisfied.

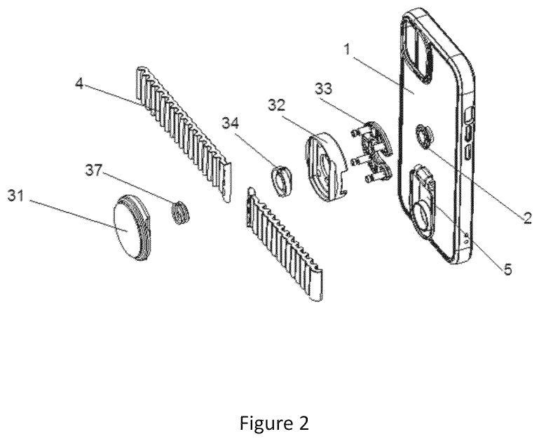

As shown in FIG. 2, be provided with a containment chamber 35 for accommodating the pushing block 34 in the upper cover 31, symmetrically be provided with two linear spouts 350 on the inner wall of the accommodating cavity 35, be symmetrically provided with two guide rails 341 on the outer wall of the pushing block 34, and the guide rails 341 are respectively inserted into the linear spout 350 correspondingly so that the pushing block 34 can slide along the linear sliding groove 350 in a straight line. Through the above arrangement, the pushing block 34 can be expanded and contracted in a straight line in the upper cover 31 so that the locking part 340 can be pushed to form a counterbuttation with the keyhole 220.

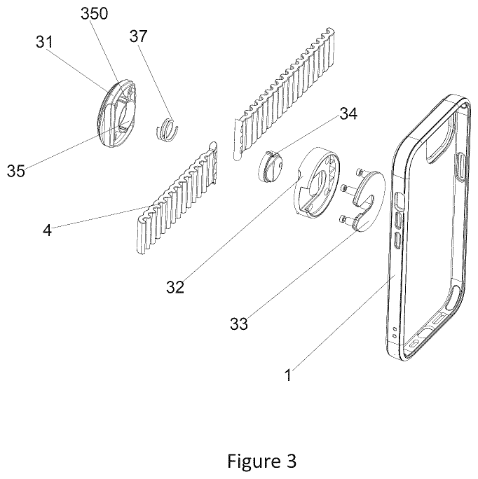

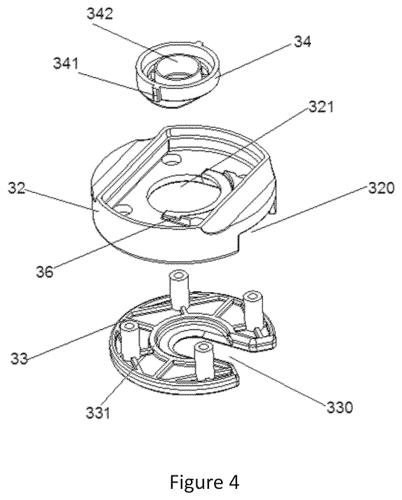

As shown in FIG. 4, in the base 32 and along the edge of the opening 321, be provided with the arc-shaped stop 36 that is used for limiting pushing block 34 to do circular turning. Specifically, the arc-shaped stop block 36 is formed by extending one of the guide rails 341 along the edge of the opening 321 to another guide rail 341, and the two ends of the arc-shaped stop 36 are respectively countered with the two guide rails 341 so that the arc-shaped stop 36 can restrain the circular rotation of the pushing block 34. As shown in FIG. 2-Figure 3, be provided with the spring 37 for promoting the slide of the pushing block 34 between the pushing block 34 and the upper cover 31. Specifically, one end of the spring 37 is butted against the push block 34, and its other end butts against the upper cover 31. Through the above-mentioned arrangement, the pushing block 34 can slide toward chuck 2 through the rebound force of the spring 37 so that the butting of the locking part 340 and the keyhole 220 can be realized through the sliding of the pushing block 34. As shown in FIG. 4, to facilitate the installation of spring 37, a spring mounting groove 342 is also arranged on the push block 34.

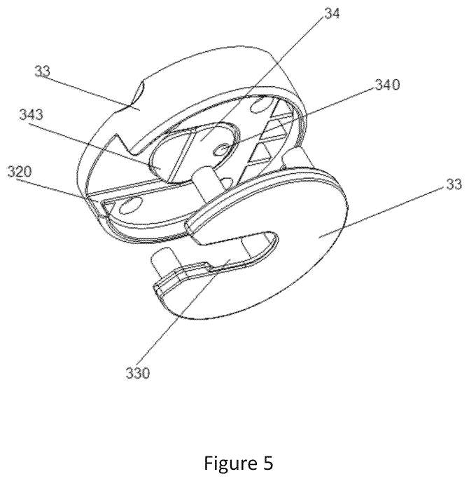

As shown in FIG. 5, the bottom of the pushing block 34 is also provided with the guide hypotenuse 343, which is convenient for inserting into the disc body 22. Through the above arrangement, the disc body 22 is inserted into the connecting seat 3 in the process, and the guiding hypotenuse 343 can play the role of guidance so that the disc body 22 is inserted more smoothly and conveniently. As shown in FIG. 4, be provided with the positioning flange 331 matched with disc body 22 at the central position of base 33. Through the above-mentioned arrangement, after the disc body 22 is inserted into the center position of the base 33, the positioning baffle plate 331 can form a counter-connection with the periphery of the disc body 22 so that the chuck 2 is inserted into the connecting seat 3, and the clamping is fixed more steadily. As shown in FIG. 7, a folding bracket 5 is arranged on the mobile phone case body 1 and is located opposite below the chuck 2, and one end of the folding bracket 5 is hinged with the mobile phone case body 1 so that after the mobile phone case body 1 is disassembled from the connecting seat 3, the folding bracket 5 can be flipped upwards and form a cover for the chuck 2. Specifically, a sleeve 51 covering and closing the chuck 2 is arranged on the folding bracket 5. More specifically, the size of the sleeve 51 is larger than that of the chuck 2.

In the embodiment, the chuck 2 is protruding on the surface of the mobile phone case body 1, and when the mobile phone is used in a mode that is not worn, the convex chuck 2 will affect the overall appearance of the mobile phone; the chuck 2 is covered by flipping up through the folding bracket 5 and utilizing the sleeve 51 so as not to affect the overall appearance of the mobile phone case body 1; In addition, the folding bracket 5 can also be flipped to a certain angle, so that the folding bracket 5 can be used to play the role of supporting the mobile phone. In conjunction with FIG. 1-FIG. 7, the specific principle of use of the present invention is described below to understand the present invention: When using, the chuck 2 is inserted into the connecting seat 3, and the disc body 22 is inserted into the base 32 from the first slot 320, and the upright post 21 is inserted into the base 32 from the second slot 330 and forms a clamping connection; In the insertion process, the disc body 22 will jack up the push block 33 upward, and after the disc body 22 is inserted into the center position of the base 32, the locking portion 330 will slide into the keyhole 220; At this moment, the pushing block 34 is affected by the rebound force of the spring 37, and the locking portion 330 is pushed downward to slide downward, and the locking portion 340 is formed against the keyhole 220, so that the purpose of locking is achieved; Finally, the fixed connector 3 and the mobile phone case body 1 are fixed on the wrist by wearing it.

When not in use, take out the connecting dock 3 and the mobile phone case body 1 from the wrist; then by pressing the mobile phone case body 1 or the connecting seat 3, the pushing block 34 and the locking portion 340 move upwards accordingly at this moment, and the spring 37 also forms compression synchronously, and then the mobile phone case body 1 is taken out from the connecting seat 3; For the beauty of the mobile phone, after the mobile phone case body 1 is taken out, the folding bracket 5 is flipped upwards and the chuck 2 is covered.

The present invention is not limited to the above embodiments, and if various alterations or deformations to the present invention do not deviate from the spirit and scope of the present invention, the present invention is also intended to include such alterations and deformations if such alterations and deformations fall within the scope of the claims and equivalent techniques of the present invention.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A strap-type phone case comprising:
A mobile phone case body, the mobile phone case body is provided with a chuck and a detachable connecting seat that is arranged on the chuck, two ends of the connecting seat are also respectively provided with a strap, and one end of the two straps is connected with each other through magnetic attraction; the chuck comprises a column protruding relative from the surface of the mobile phone case body and a disc body arranged at the end of the column, and the diameter of the disc body is greater than the diameter of the column; the side end of a connecting seat is respectively provided with a first slot for disc body insertion and a second slot for column insertion, where the width dimension of the first slot is greater than the width dimension of the second slot, so that after the disc body is inserted, forming a clamping connection with the connecting seat; further providing a retractable pushing block inside the connecting seat, and the end of the pushing block is provided with a locking portion; a plurality of keyholes are uniformly arranged in the circumferential direction of the disc body, and after the pushing block stretches out in the direction of the disc body, the locking part can optionally be butted against one of the keyholes, so that the mobile phone case body is locked and fixed on the connecting seat after adjusting the angle.

2. The strap-type mobile phone case of claim 1, wherein: the connecting seat comprises an upper cover and a base, where the first slot is arranged on the base, and the second slot is arranged on the base after the disc body is inserted into the first slot, the upper end of the disc body forms a counter with the bottom end of the base, and the lower end of the disc body forms a counter with the upper end of the base.

3. The strap-type mobile phone case of claim 2 further provides a containment chamber for accommodating the pushing block in the upper cover, which is symmetrically provided with two linear spouts on the inner wall of the containing cavity and is provided with two symmetrical guide rails on the outer wall of the pushing block, and the guide rails are inserted into the linear spout respectively so that the pushing block can slide in a straight line along the linear sliding groove.

4. The strap-type mobile phone case of claim 1 is further provided with a spring for promoting the slide of the pushing block between the pushing block and the upper cover.

5. The strap-type mobile phone case of claim 1, wherein: at the bottom center position of the pedestal, the opening hole for the locking part stretches out to the disc body direction.

6. The strap-type mobile phone case of claim 5, wherein: the pedestal and along the edge of the opening is provided with an arc-shaped stop used for limiting the pushing block to a circular rotation.

7. The strap-type mobile phone case of claim 1, wherein: the bottom of the pushing block is provided with the guiding hypotenuse the insertion of the disc body.

8. The strap type mobile phone case of claim 1, further provided with the positioning flange matches the disc body at the central position of described base.

9. The strap-type mobile phone case of claim 1, wherein: the two bands are alternately provided with bumps and grooves in their length directions, so that after the two bands are connected with each other, the bumps can be correspondingly inserted into the grooves to form a plug-in connection.

10. The strap type mobile phone case of claim 1, wherein: a folding bracket is arranged on the mobile phone case body and is positioned below the chuck, and one end of the folding bracket is hinged with the mobile phone case body, so that after the mobile phone case body is disassembled from the connecting seat, the folding bracket can be flipped upwards and covers the chuck.
